(19) United States
(12) Patent Application Publication
(10) Pub. No.: US 2020/0108803 A1
(43) Pub. Date: Apr. 9, 2020

(54) METHOD FOR MONITORING A VEHICLE AND VEHICLE LOCATION MONITORING SYSTEM FOR AN AUTOMATED CARWASH

(71) Applicant: SONNY'S ENTERPRISES, INC., Tamarac, FL (US)

(72) Inventors: PAUL FAZIO, PLANTATION, FL (US); ANTHONY ANALETTO, WESTON, FL (US); REGINALD FLANAGAN, POMPANO BEACH, FL (US)

(21) Appl. No.: 16/563,324

(22) Filed: Sep. 6, 2019

Related U.S. Application Data
(60) Provisional application No. 62/743,224, filed on Oct. 9, 2018.

(51) Int. Cl. B60S 3/00; G06F 3/14; G01V 8/20; B60S 3/04

(52) U.S. Cl. CPC B60S 3/004; B60S 3/04; G01V 8/20; G06F 3/14

(57) ABSTRACT

A method operates a carwash having a carwash tunnel. A vehicle is conveyed into the carwash via a conveyor. At least a position, a length and/or a height of the vehicle traversing the carwash is captured. A progression of the vehicle going from a first checkpoint to a downstream second check point is monitored. The conveyor is stopped if the vehicle does not make it to the downstream second checkpoint in an allotted time period.

### CROSS-REFERENCE TO RELATED APPLICATION

This application claims the priority, under 35 U.S.C. § 119, of provisional application No. 62/743,224, filed Oct. 9, 2018; the prior application is herewith incorporated by reference in its entirety.

### BACKGROUND OF THE INVENTION

### Field of the Invention

The invention relates to automated carwashes and the ability to detect and monitor a vehicle that is traversing a carwash tunnel via laser sensors.

Automatic carwashes are configured to process as many vehicles as possible in a given period of time. One goal of these car washing systems is to maintain a constant flow of vehicles through the carwash. In order to achieve this goal, it is imperative to detect when a vehicle stops moving in a carwash tunnel of a carwash. It is best to detect vehicle stoppages using existing components of the carwash or to add as few new components as possible. Such existing components as controllers, cameras and sensors can be further programmed or used for detecting the vehicle stoppages.

### SUMMARY OF THE INVENTION

It is accordingly an object of the invention to provide a method for monitoring a vehicle and a vehicle location monitoring system for an automated carwash that overcome the above-mentioned disadvantages of the prior art devices and methods of this general type, which is technically easy to implement, is effective, and uses inexpensive components.

With the foregoing and other objects in view there is provided, in accordance with the invention, an automated carwash. The automated carwash has a carwash tunnel, a conveyor for conveying vehicles in the carwash tunnel, and a plurality of laser sensors disposed throughout the carwash tunnel and defines a plurality of checkpoints. The laser sensors detect a presence of a vehicle disposed in the carwash tunnel. A processor is connected to the laser sensors and monitors a progression of a vehicle within the carwash tunnel. The processor shuts down the conveyor if it determines that a vehicle does not make it to a given checkpoint in an allotted time period.

In automated car wash tunnels, rollers or conveyor belts push a vehicle through the tunnel while different pieces of equipment wash the vehicle. At high volume locations, vehicles travel on the conveyors bumper-to-bumper with only a few feet spacing the vehicles apart. If a driver steps on the brake pedal while going through the car wash, it may cause the vehicle to jump a roller or stop moving on the conveyor belt; the vehicle becomes stationary before a second roller reaches the tire position to continue to push the vehicle or the vehicle cannot be further moved forward on the conveyor belt. If the trailing vehicle is only a few feet behind, this situation can potentially cause a collision inside the tunnel. The purpose of the invention is to use laser sensors throughout the car wash tunnel to identify the location of a vehicle while inside an automated car wash tunnel. Laser sensors detect and profile a height and a length of a vehicle upon entering the car wash tunnel. The vehicle location is monitored as it progresses through the tunnel utilizing these sensors, if the vehicle is not detected by a sensor at the time it is expected to reach a sensor check point, the conveyor and the equipment is signaled to stop. This system would avoid potential collisions, but yet maintain the high through put of these very busy car wash locations.

In accordance with an added feature of the invention, a display is connected to the processor.

In accordance with another feature of the invention, the laser sensors in conjunction with the processor model the carwash tunnel and display a size and position of all vehicles disposed within the carwash tunnel.

In accordance with a further feature of the invention, the processor outputs to the display data for displaying the model visually and therefore shows to a carwash operator the carwash tunnel and the position and size of all the vehicles in the carwash tunnel.

In accordance with an additional feature of the invention, an alarm is connected to the processor. In this manner a carwash operator is immediately alerted to the vehicle stoppage within the carwash.

In accordance with yet another added feature of the invention, the laser sensors in conjunction with the processor determine a vehicle stoppage in the carwash tunnel.

In accordance with a further added feature of the invention, upon detection of the vehicle stoppage, the controller outputs an alarm signal to the alarm causing an activation of the alarm.

With the foregoing and other objects in view there is provided, in accordance with the invention, a method for operating a carwash. The method includes conveying a vehicle into the carwash via a conveyor, capturing at least one of a position, a length or a height of the vehicle traversing the carwash, monitoring a progression of the vehicle going from one checkpoint to a further downstream check point, and stopping the conveyor if the vehicle does not make it to the further downstream checkpoint in an allotted time.

In accordance with an added mode of the invention, there is the step of monitoring the distance between any two vehicles within the carwash and shutting down the conveyor if a minimal distance between the vehicles is violated.

In accordance with an added mode of the invention, there is the step of providing laser sensors for capturing at least one of the position, the length or the height of the vehicle within the carwash resulting in captured data.

In accordance with another mode of the invention, there is the step of outputting the captured data to a controller which determines whether the vehicle is no longer being conveyed by the conveyor.

In accordance with a further mode of the invention, there is the step of using the captured data to model the carwash and the position of all vehicles disposed in the carwash. The model with the position of all the vehicles disposed in the carwash is ideally displayed on a display which is monitored by a carwash operator.

In accordance with an additional mode of the invention, there is the step of activating an alarm if it is determined that the vehicle is no longer being conveyed by the conveyor or if the vehicle does not make it to the further downstream checkpoint in the allotted time.

In accordance with another added mode of the invention, there is the step of displaying the position of an improperly stopped vehicle on a display to be monitored by an operator of the carwash. In addition, upon the detection of a stopped vehicle a necessary corrective action is also displayed. In this manner, the carwash operator can quickly set about to resolve a faulty situation.

Other features which are considered as characteristic for the invention are set forth in the appended claims.

Although the invention is illustrated and described herein as embodied in a method for monitoring a vehicle and a vehicle location monitoring system for an automated carwash, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a carwash tunnel with laser sensors according to the invention; and

FIG. 2 is a flow chart for explaining a method according to the invention.

### DETAILED DESCRIPTION OF THE INVENTION

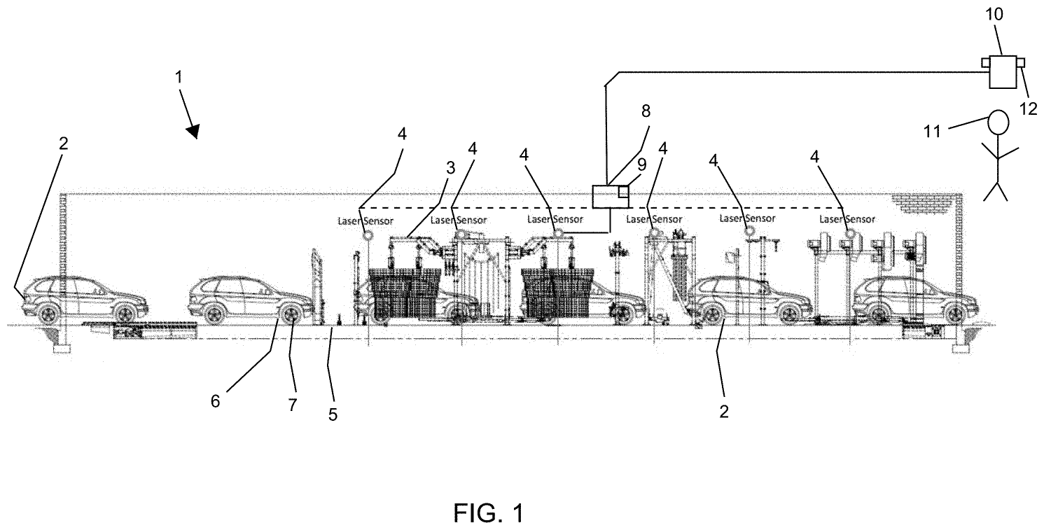

Referring now to the figures of the drawings in detail and first, particularly to FIG. 1 thereof, there is shown a vehicle carwash tunnel 1. Within the tunnel 1 are a plurality of vehicles 2 traversing the tunnel 1 and going from one carwash station 3 to another. The vehicles 2 are transported by a conveyor 5 having a plurality of rollers 6 which engage a vehicle wheel 7 for moving the vehicle 2 along the conveyor 5. Throughout the carwash tunnel 1 is a plurality of laser sensors 4, also referred to as laser checkpoints 4, that constantly monitor the position of the vehicles 2 in the tunnel 1 (e.g. vehicle length, vehicle height and position in tunnel). When a carwash customer accidently presses his/her brake or strongly turns a front wheel there is a chance that the wheel 7 will jump over the transportation roller 6 and the vehicle 2 is no longer being transported by the conveyor 5. The laser sensor 4 is used to either directly determine that the vehicle 2 has stopped or a watchdog timer 9 of a processing unit 8 determines that the vehicle 2 has not made it to a next laser checkpoint 4 in an allotted period of time. At this point the processing unit 8 shuts down the conveyor system 5 from transporting any vehicles 2.

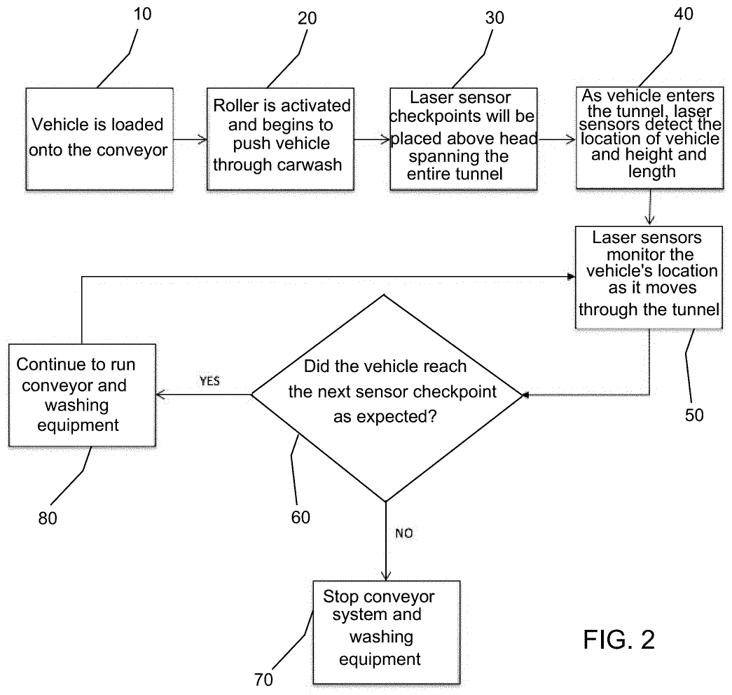

FIG. 2 is a flow chart diagramming the basic principles of the invention. In step 10 the vehicle 2 is loaded onto the conveyor 5. In step 20, the roller 6 is activated and pushes the vehicle 2. In step 30, the laser sensors 4 capture an entire image of the tunnel 1 and the positions of vehicles 2 within the tunnel 1 (e.g. modeling the tunnel 1 with the vehicles 2). In step 40, a newly entering vehicle 2 is detected by the laser sensor(s) 4 and its position, length and height are determined. In step 50, timers are set for monitoring the time it takes the vehicle 2 to progress from one laser sensor checkpoint 4 to the next laser sensor checkpoint 4 and the laser sensors 4 in conjunction with the controller 8 monitor the general progression of the vehicle 2 within the tunnel 1. In step 60, it is determined if the vehicle 2 made it to the next laser sensor checkpoint 4 in the allotted time. If the vehicle 2 did not make it to the next laser sensor checkpoint 4 in time, the controller 8 shuts down the operation of the conveyor, step 70. The controller 8 can activate a display 10 with an alarm 12 or other signaling device to catch the attention of a carwash operator 11 to make him/her aware of an unacceptable situation detected in the carwash tunnel 1. Additionally, the display 10 will show the operator 11 the detected situation and what is the appropriate course of action to address the detected situation as directed by the controller 8. The alarm 12 is activated by an output signal from the controller 8 and can be an audible alarm, a visual alarm, a haptic alarm and/or a message. On the other hand, if the vehicle 2 did make it to the next laser sensor checkpoint 4 in time, the conveyor 5 continues to operate as usual, step 80.

The processor 8 receives all of the input data from all of the laser sensors 4 and models the tunnel 1 with the size and position of all of the vehicles 2 within the tunnel 1. The display 10 receives the output data from the processor and displays the modeled tunnel 1 to the operator 11 so that the operator has a visual on the continuous operation of the carwash.

1. An automated carwash, comprising:
a carwash tunnel;
a conveyor for conveying vehicles in said carwash tunnel;
a plurality of laser sensors disposed throughout said carwash tunnel and defining a plurality of checkpoints, the laser sensors detecting a presence of a vehicle disposed in the carwash tunnel; and
a processor connected to said laser sensors and monitoring a progression of the vehicle within said carwash tunnel, said processor shutting down said conveyor if it determines the vehicle does not make it to a given checkpoint in an allotted time period.

2. The automated carwash according to claim 1, further comprising a display connected to said processor.

3. The automated carwash according to claim 2, wherein said laser sensors in conjunction with said processor model said carwash tunnel and display a size and position of all vehicles disposed within said carwash tunnel on said display.

4. The automated carwash according to claim 3, wherein said processor outputting to said display, data for displaying the model visually showing to a carwash operator said carwash tunnel and the position and size of all the vehicles in the carwash tunnel.

5. The automated carwash according to claim 1, further comprising an alarm connected to said processor.

6. The automated carwash according to claim 5, wherein said laser sensors in conjunction with said processor determining a vehicle stoppage in said carwash tunnel and shutting down said conveyor.

7. The automated carwash according to claim 6, wherein upon detection of the vehicle stoppage, said controller outputting an alarm signal to said alarm causing an activation of said alarm.

8. A method for operating a carwash, which comprises the steps of:
conveying a vehicle into the carwash via a conveyor;
capturing at least one of a position, a length or a height of the vehicle traversing the carwash;
monitoring a progression of the vehicle going from one checkpoint to a further downstream check point; and
stopping the conveyor if the vehicle does not make it to the further downstream checkpoint in an allotted time period.

9. The method according to claim 8, which further comprises monitoring a distance between any two adjacent vehicles within the carwash and shutting down the conveyor if a minimal distance between the two adjacent vehicles is violated.

10. The method according to claim 8, which further comprises providing laser sensors for capturing at least one of the position, the length or the height of the vehicle within the carwash resulting in captured data.

11. The method according to claim 10, which further comprises outputting the captured data to a controller which determines whether the vehicle is no longer being conveyed by the conveyor.

12. The method according to claim 10, which further comprises using the captured data to model the carwash and the position of all vehicles disposed in the carwash.

13. The method according to claim 12, which further comprises displaying the model with the position of all the vehicles disposed in the carwash on a display to be monitored by a carwash operator.

14. The method according to claim 11, which further comprises activating an alarm if it is determined that the vehicle is no longer being conveyed by the conveyor or if the vehicle does not make it to the further downstream checkpoint in the allotted time period.

15. The method according to claim 8, which further comprises displaying the position of an improperly stopped vehicle on a display to be monitored by an operator of the carwash.

16. The method according to claim 8, wherein upon detection of a stopped vehicle, displaying a necessary corrective action on a display.
